(19) United States
(12) Patent Application Publication
(10) Pub. No.: US 2012/0139417 A1
(43) Pub. Date: Jun. 7, 2012

(54) SMART LIGHTING SYSTEM AND METHOD THEREOF

(76) Inventors: Sergei Yuryevich Mironichev, Moscow (RU); Pavel Alpatov, San Diego, CA (US)

(21) Appl. No.: 13/158,256

(22) Filed: Jun. 10, 2011

Related U.S. Application Data
(60) Provisional application No. 61/353,327, filed on Jun. 10, 2010.

(51) Int. Cl. H05B 37/02; F21V 29/00

(52) U.S. Cl. 315/86; 315/151; 315/113; 362/249.02

(57) ABSTRACT

A programmable and remotely controlled lighting system employing LED lamps is disclosed herein. The system and methods of the present invention are ideally suited for residential or commercial buildings, court yards, business parks, universities, etc. Initially light sensors are provided to the system measuring available natural and artificial light. A system or area brightness is controlled programmably or remotely via a dimmer with PWM (pulse-width-modulated) power for reduced energy consumption. Wireless command and control is provided by microcontrollers with radio frequency transmitters and receivers. Additional circuitry is included to adequately compensate for transient input voltage. The lighting system further may be easily implemented to other systems able to be controlled by computer such as video surveillance systems and

### PRIORITY CLAIM

This patent application contains subject matter claiming benefit of the priority date of U.S. Prov. Pat. App. Ser. No. 61/353,327 filed on Jun. 11, 2010, entitled SMART LIGHTING SYSTEM AND METHOD THEREOF; additionally this patent application contains subject matter claiming benefit of the priority date of U.S. patent application Ser. No. 12/537,111 filed on Aug. 6, 2009, entitled LIGHT CONTROL DEVICE, which contains subject matter claiming benefit of international patent application No. PCT/RU2008/000508 filed on Aug. 7, 2008.

### BACKGROUND OF THE INVENTION

1. Field of the Invention

The present invention relates generally to improvements in lighting systems allowing for energy savings and conservation of raw and manufactured materials. Additionally, the present invention generally relates to reducing costs to design and implement lighting systems and further lighting system designs capable of handling undesirable fluctuations in supply voltage. More particularly, in a preferred embodiment, the present invention pertains to an advanced LED lighting system and lamp devices and further to methods for optimal control thereof.

2. Description of the Art

Light emitting diodes (LEDs) have been known for several decades as providing relatively high luminousness as compared to incandescent light bulbs at a given energy consumption (in Watts, for example). Lighting systems employing LED lamps enjoy additional advantages over other light emitters including longer lifetime, reduced size and increased durability. However, significant obstacles and disadvantages have prevented more widespread use of LEDs in major lighting applications. Among these disadvantages are temperature sensitivity and also sensitivity to changes in voltage. Also of significance, the initial cost of LED lighting systems is much more than incandescent or fluorescent systems partly due to the more complex drive circuitry required.

As partial motivation for the present invention, recent advancements in electronic and wireless transmission could be applied to LED lighting system to significantly overcome the disincentive to incur the high initial cost of implementation. More specifically, control microprocessors have become less expensive and emergence of reliable wireless initiatives, such as the ZigBee standard using small, low power, short range transmission. Such wireless control is easier and cheaper to install than wired control systems.

Accordingly, it is an object of the present invention to provide an LED lighting system that uses advanced microcontrollers to maintain precise electrical and illumination parameters. It is an additional object of the present invention to employ a ZigBee wireless standard to optionally adjust said control parameters. It is further an object to employ PWM (Pulse Width Modulation) current control to adjust LED brightness. It is yet still further an object of the present invention to provide monitoring of LED temperature to further improve lamp and system reliability. It is further an object of the present invention to provide an LED lamp that can handle fluctuations in supply voltage preventing damage to the LED lamp. It is further an object of the present invention to configure a self-test function to the microcontroller further configured to send an alert to a control location for the benefit of maintenance personnel. Many other beneficial design characteristics are additionally provided by the present invention.

### BRIEF SUMMARY OF THE INVENTION

The present invention specifically addresses and alleviates the above mentioned deficiencies associated with the prior art. More particularly, the present invention, in a first aspect is a lighting system providing lighting over an area, the system comprising: a plurality of LED (light emitting diode) lamps; a plurality of light sensors throughout the area sensing artificial and natural light; a first microcontroller including integrated transceiver coupled to each of the plurality of LED lamps; a second microcontroller including integrated transceiver for proving remote programmable or ad hoc control of the lighting system; and a rotary control dimmer proving pulse width modulated control (PWM) and thereby providing reduced amounts of power to individual LEDs based on the sensing artificial and natural light.

The invention in this aspect is additionally characterized wherein each of the plurality of LED lamps further comprises an EMI (electromagnetic interference) filter providing smoothness to a transient initial supply voltage; a diode bridge coupled to an output of the EMI filter for rectifying power; an LED driver circuit; and a voltage converter, the voltage converter together with the LED driver circuit providing a correct voltage to an LED emitter. Still further in this aspect, this invention comprises a video surveillance system integrated to the lighting system; a security system integrated to the lighting system and the video surveillance system; and an emergency backup generator providing emergency power to the lighting system in an event of a normal power failure.

Still further, the invention may be characterized wherein each of the plurality of LED lamps further comprises an Edison screw having an electrical contact, a first PCB layer coupled to the electrical contact, and a second PCB layer. The second PCB layer further has a plurality of LEDs configured thereto wherein a heat sink is further configured between the first and second PCB layers. The first and second PCB layers are additionally secured by a plurality of elongated bolts.

The invention in this aspect is yet further characterized wherein the heat sink comprises a plurality of circular aluminum plates alleged perpendicularly with respect to the plurality of elongated bolts; wherein further, a total of four elongated bolts are securing quarter portions of the plurality of aluminum plates. Additionally, each the plurality of LED lamps further comprises a first LED at a center of the second PCB layer, an arrangement of six LEDs arranged concentrically around the first LED; and an arrangement of eight LEDs arranged concentrically around the first LED and the arrangement of six LEDs. A protective housing is additionally provided to the first PCB layer tapering to the stem or Edison screw.

In a second aspect, the invention may be characterized as a smart lighting system comprising an LED (light emitting diode) lamp, the LED lamp comprising: an EMI (electromagnetic interference) filter providing smoothness to a transient initial supply voltage; a diode bridge coupled to an output of the EMI filter for rectifying power; an LED driver circuit; a voltage converter, the voltage converter together with the LED driver circuit providing a correct voltage to an LED emitter; a rotary controller further providing power to the LED emitter in pulses and thereby controlling a brightness; a microcontroller for command and control of a plurality of parameters of the light control system; and a transceiver integrated to the microcontroller for receiving command and control instructions.

Also in this aspect, the invention is additionally characterized as further comprising: a light sensor. As in the preferred embodiment, the LED lamp is a first LED lamp, the lighting system further comprising a second LED lamp and a plurality of subsequent LED lamps, and wherein the microcontroller is in wireless communication with a remote control device; and wherein a lighting system brightness is adjusted by a user based on a total illumination sensed by the light sensor (natural light plus artificial light). In a preferred embodiment, the remote control device is wirelessly coupled to a personal computer (or configured therewith) for providing command and control functions.

Additionally, the lighting system herein may easily be configured to a video surveillance system in a residential building or larger group of buildings such as a university campus. Further, an emergency backup generator can provide emergency power to the lighting system in an event of a normal power failure.

An additional aspect of the present invention includes the physical construction of an LED lamp comprising: an Edison screw having an electrical contact; a first PCB layer coupled to the electrical contact; a second PCB layer, the second PCB layer further comprising a plurality of LEDs; and a heat sink configured between the first and second PCB layers. In a preferred embodiment, the heat sink is secured by a plurality of elongated bolts. More specifically, the heat sink comprises a plurality of circular aluminum plates alleged perpendicularly with respect to the plurality of elongated bolts; wherein further four elongated bolts secure quarter portions of the plurality of aluminum plates.

As stated, an LED lamp of the present invention further has a plurality of LEDs. More specifically, the plurality of LEDs has a first LED at a center of the second PCB layer; an arrangement of six LEDs arranged concentrically around the first LED; and an arrangement of eight LEDs arranged concentrically around the first LED and the arrangement of six LEDs. A protective housing is provided to a first PCB layer tapering to an Edison screw. Also, the Edison screw has an electrical contact with the first PCB layer coupled to the electrical contact; a second PCB layer, the second PCB layer further comprising a plurality of LEDs; and a heat sink configured between the first and second PCB layers, and secured by a plurality of elongated bolts.

In yet another aspect, the invention is a method of providing lighting over a relatively large area comprising the steps of: providing a plurality of LED lamps being an analogue of 100 W incandescent lamps; configuring a first microcontroller to the LED lamps; sensing a natural and an artificial light with a light sensor; dimming or brightening the plurality of LEDs based on the sensing using a PWM (pulse-width-modulated) current controller; providing a second microcontroller in wireless communication with the first microcontroller, wherein a user is able to remotely and programmably control system parameters via the second microcontroller.

These, as well as other advantages of the present invention will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematical representation of a preferred lighting system of the present invention;

FIG. 2A is a perspective view of a preferred LED lamp embodiment of the present invention;

FIG. 2B is an additional perspective view thereof from an above view point;

FIG. 2C is a side aspect view of the LED lamp embodiment;

FIG. 2D is an end view of the LED lamp illustrating a preferred arrangement;

FIG. 3A is a functional block diagram of an LED lamp control circuitry and related electronics; and

FIG. 3B is a block diagram of a wireless brightness controller of the present invention.

### DETAILED DESCRIPTION OF PREFERRED EMBODIMENTS

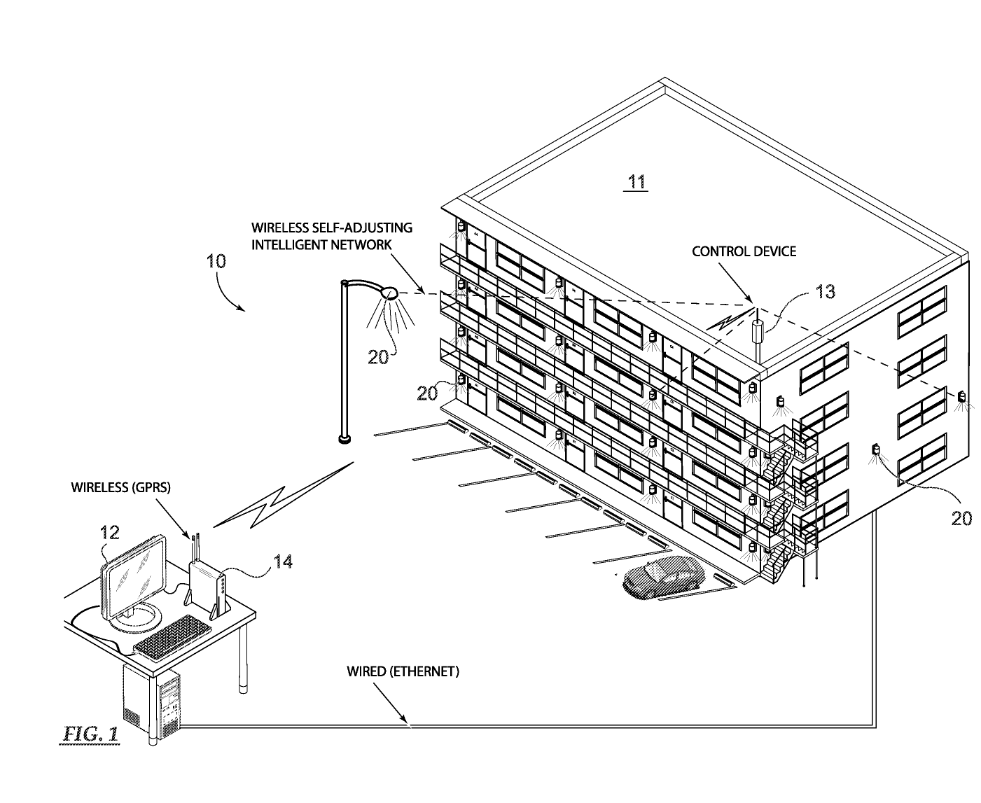

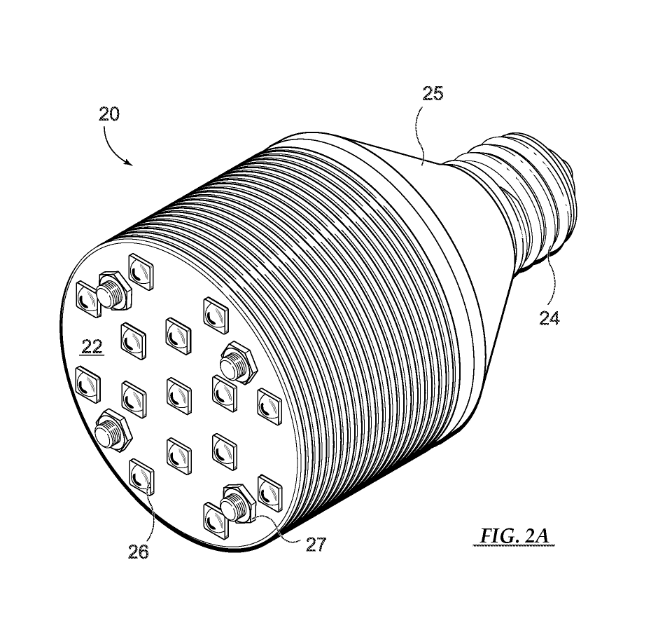

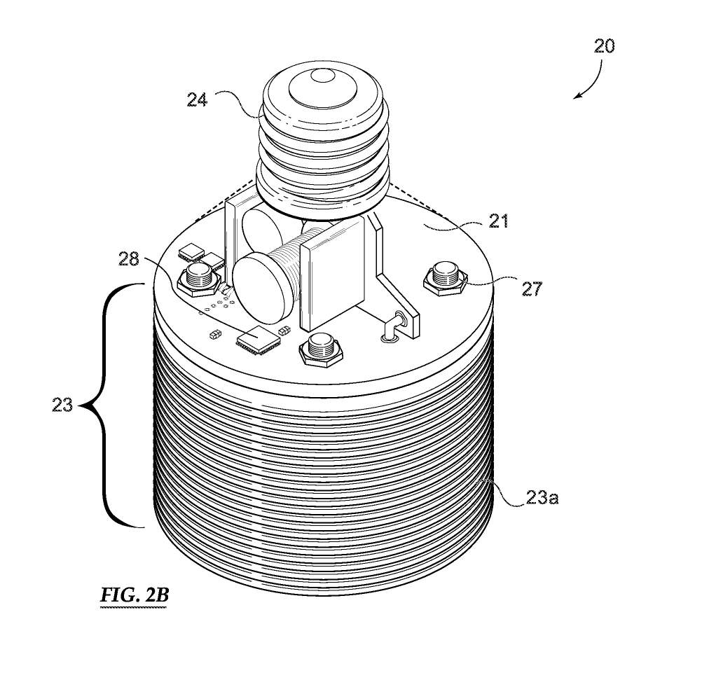

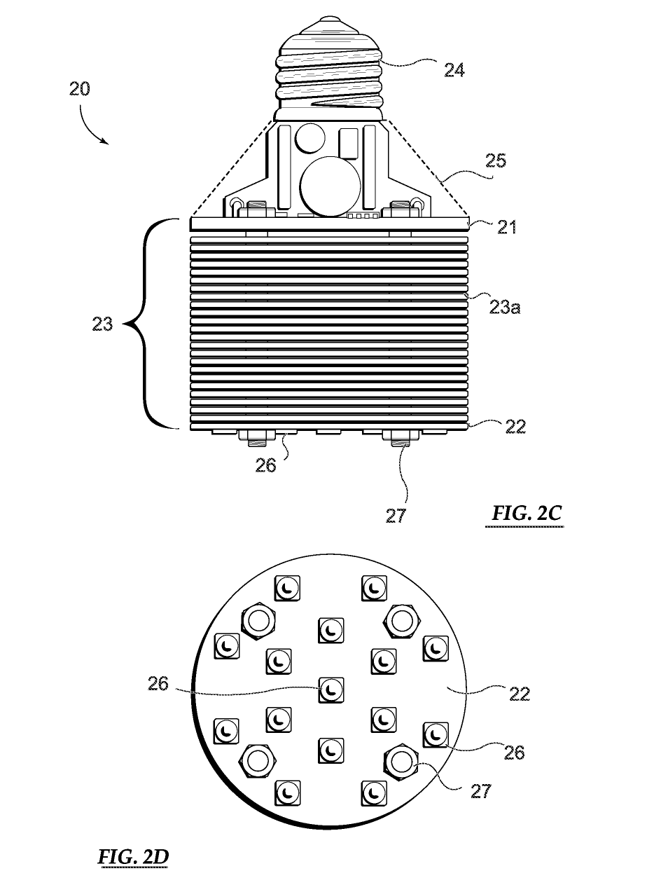

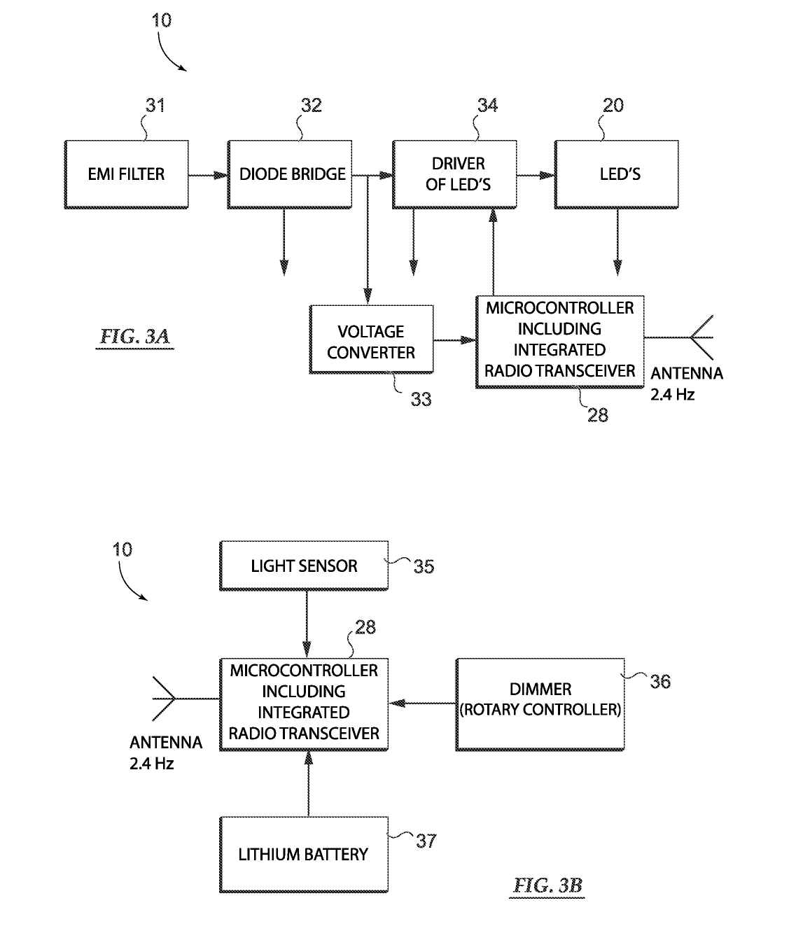

Initially with reference to FIG. 1, a schematical illustration is provided as an overview of a first preferred lighting system 10. It is envisioned that the system 10 can be ideal for residential or commercial buildings, a business park, shopping center, university campus etc. Further, the system 10 is programmable to provide a desired illumination as desired by a user. Also the system can programmably provide situational lighting since motion sensors are additionally configured to the present invention. Similarly, various light sensors 35 (FIG. 3B) are provided throughout a control area to provide input to a control microprocessor 13, 28. Alternatively, the light sensor and control microprocessor 28 can be integrated to the first PCB layer 21 of an individual LED lamp 20 (FIG. 2B). In yet another alternative, the first PCB layer has a built-in microprocessor and the remote microcontroller 13 is additionally configured to the internet wherein remote control is provided via a computer 12 and the internet or a smart phone.

As in the preferred embodiment, various LED lamps 20 are provided as shown being controlled programmably or ad hoc. Further, a lighting system brightness is adjusted by the system based on a total illumination sensed by the light sensor 35 (natural light plus artificial light). As stated in a preferred embodiment, the remote control device 13, 14 is wirelessly coupled to a personal computer 12 (or configured therewith) for providing command and control functions.

Additionally, the lighting system 10 herein may easily be configured to a video surveillance system or a climate control system in a residential building or larger group of buildings such as a university campus. For example, the system 10 could be programmed to leave a particular area unlighted unless there is a security breach detected by the surveillance system. Further, an emergency backup generator can provide emergency power to the lighting system 10 in an event of a normal power failure.

With regard to FIG. 2A through FIG. 2D various views of an LED lamp 20 are illustrated. In this configuration, the LED lamp 20 comprising multiple LEDs 26 can be configured to a conventional (incandescent) lamp holder. As shown, a first printed circuit board (PCB) 21 is configured to an upper end of a stem (or Edison screw 24) typically received by the lamp holder. A protective housing 25 is also provided. The PCB 21 more specifically comprises electronics 28, 31, 32, 33, 34, 35, 36, 37 to achieve specific objectives of the present invention as disclosed herein. Development of the present invention 10 was motivated by a desire to save energy taking advantage of improvements in LEDs and related electronics including wireless communications. Further, the invention is motivated by a desire to save in raw materials as transition to LED technology also has the advantage of longer lasting light bulbs. Importantly, the LED lamps 20 and systems 10 herein comprise a microcontroller 13, or several microprocessors 28 maintaining optimal parameters such as voltage, current, temperature and illumination. The microprocessor(s) are further coupled to antenna providing wireless command and control of individual lamps 20 or systems 10 comprising multiple lamps.

Further with regard to FIG. 2C and FIG. 2D, a second PCB layer 22 further comprises a plurality of LEDs 26. A heat sink 23 is additionally configured between the first 21 and second 22 PCB layers. In a preferred embodiment, the heat sink 23 is secured by a plurality of elongated bolts. As shown in FIG. 2D, each of four elongated bolts 27 secures a quarter portion of a plurality of circular aluminum plates 23a. The plates 23a are optimally spaced and provide a large surface area so that air can remove heat by convection. As shown in FIG. 2C, the circular aluminum plates 23a are alleged perpendicularly with respect to the plurality of elongated bolts 27. Temperature monitoring is additionally contemplated by the present invention as an indicator of LED 20 performance. A self-test system is further available in insure proper LED 26 function with automatic alerts provided to maintenance personnel.

Still further with regard to FIG. 2D a first LED 26 is provided at a center of the second PCB layer 22. Additionally an arrangement of six LEDs 26 is provided and arranged concentrically around the first LED 26. An arrangement of eight LEDs 26 are then arranged concentrically around the first LED 26 and the arrangement of six LEDs 26.

With regard to FIG. 3A, a functional block diagram of components is provided by way of example. Initially, an EMI filter 31 is provided to a supply voltage that may fluctuate due transient conditions existing in some power supply networks. Following the filter 31, power is provided to the diode bridge 32 functioning as a bridge rectifier. Next, current flows to the LED driver circuit 34 that, in conjunction with the voltage converter 33, provides the correct voltage and current to an individual LED 26 or an LED array 20. Microprocessor 13 provides automatic feedback and control of parameters as further detailed herein.

Regarding FIG. 3B, a block diagram of a brightness control function is illustrated. A separate microprocessor could be provided to the control circuit or this component may be combined to microprocessor 28. The controller 28 can be manipulated remotely via ZigBee standard 13, 14 as explained herein to adjust brightness remotely. As shown, light sensor 35 is provided to the lighting system to automatically maintain precise illumination to the lighting system 10, if for example, the system works in conjunction with natural light sources. The microcontroller 28 is further coupled to a dimmer (PWM type) 36 for example that can essentially control forward current to LEDs 26 without excessive losses.

The present invention provides many other design features generally for system reliability, longevity and energy savings. For example as alluded to herein, the system 10 can be coupled to a motion sensor to illuminate areas in an as needed basis. Also, LED lamps 20 are designed with required insulation and heat sinking 23 as to avoid adverse temperature effects in LED 26 operation. An additional benefit of the present invention is that electrical system wiring would not have to be changed to implement the advantages of the smart lighting system 10 herein; and therefore cost savings will be more quickly realized without having to completely retrofit existing systems.

By way of example and not by way of limitation, basic technical parameters of smart lighting system 10 herein are as follows: power consumption 20 W (an analogue of 100 W incandescent lamps and therefore five (5) times more energy saving); supply voltage range is 100V-300V providing reliability under transient conditions; ZigBee 2.4 Hz radio band (intended to be simpler and cheaper than other similar standards such as Bluetooth).

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Smart Lighting System And Method Thereof as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A lighting system providing lighting over an area, the system comprising:
a plurality of LED (light emitting diode) lamps;
a plurality of light sensors throughout the area sensing artificial and natural light;
a first microcontroller including integrated transceiver coupled to each of the plurality of LED lamps;
a second microcontroller including integrated transceiver for proving remote programmable or ad hoc control of the lighting system; and
a rotary control dimmer proving pulse width modulated control (PWM) and thereby providing reduced amounts of power to individual LEDs based on the sensing artificial and natural light.

2. The lighting system of claim 1, each of the plurality of LED lamps further comprising:
an EMI (electromagnetic interference) filter providing smoothness to a transient initial supply voltage;
a diode bridge coupled to an output of the EMI filter for rectifying power;
an LED driver circuit; and
a voltage converter, the voltage converter together with the LED driver circuit providing a correct voltage to an LED emitter.

3. The lighting system of claim 1 further comprising:
a video surveillance system integrated to the lighting system;
a security system integrated to the lighting system and the video surveillance system; and
an emergency backup generator providing emergency power to the lighting system in an event of a normal power failure.

4. The lighting system of claim 1, each of the plurality of LED lamps further comprising:
an Edison screw having an electrical contact;
a first PCB layer coupled to the electrical contact;
a second PCB layer, the second PCB layer further comprising a plurality of LEDs; and
a heat sink configured between the first and second PCB layers, and secured by a plurality of elongated bolts.

5. The lighting system of claim 4, the heat sink comprising a plurality of circular aluminum plates alleged perpendicularly with respect to the plurality of elongated bolts; wherein further four elongated bolts secure quarter portions of the plurality of aluminum plates.

6. The lighting system of claim 4, each the plurality of LED lamps further comprising:
a first LED at a center of the second PCB layer;
an arrangement of six LEDs arranged concentrically around the first LED; and
an arrangement of eight LEDs arranged concentrically around the first LED and the arrangement of six LEDs.

7. The lighting system of claim 4 further comprising a protective housing to the first PCB layer.

8. A lighting system comprising an LED (light emitting diode) lamp, the LED lamp comprising:
an EMI (electromagnetic interference) filter providing smoothness to a transient initial supply voltage;
a diode bridge coupled to an output of the EMI filter for rectifying power;
an LED driver circuit;
a voltage converter, the voltage converter together with the LED driver circuit providing a correct voltage to an LED emitter;
a rotary controller further providing power to the LED emitter in pulses and thereby controlling a brightness;
a microcontroller for command and control of a plurality of parameters of the light control system; and
a transceiver integrated to the microcontroller for receiving command and control instructions.

9. The lighting system of claim 8, further comprising: a light sensor, and wherein the LED lamp is a first LED lamp, the lighting system further comprising a second LED lamp and a plurality of subsequent LED lamps, and wherein the microcontroller is in wireless communication with a remote control device; and wherein a lighting system brightness is adjusted by a user based on a total illumination sensed by the light sensor (natural light plus artificial light).

10. The lighting system of claim 9 wherein the remote control device is wirelessly coupled to a personal computer for providing command and control functions.

11. The lighting system of claim 8 further comprising:
a video surveillance system integrated to the lighting system;
a security system integrated to the lighting system and the video surveillance system; and
an emergency backup generator providing emergency power to the lighting system in an event of a normal power failure.

12. The lighting system of claim 8, the LED lamp further comprising:
an Edison screw having an electrical contact;
a first PCB layer coupled to the electrical contact;
a second PCB layer, the second PCB layer further comprising a plurality of LEDs; and
a heat sink configured between the first and second PCB layers, and secured by a plurality of elongated bolts.

13. The lighting system of claim 12, the heat sink comprising a plurality of circular aluminum plates alleged perpendicularly with respect to the plurality of elongated bolts; wherein further four elongated bolts secure quarter portions of the plurality of aluminum plates.

14. The lighting system of claim 12, the plurality of LEDs comprising:
a first LED at a center of the second PCB layer;
an arrangement of six LEDs arranged concentrically around the first LED; and
an arrangement of eight LEDs arranged concentrically around the first LED and the arrangement of six LEDs.

15. The lighting system of claim 12 further comprising a protective housing to the first PCB layer.

16. An LED (light emitting diode) lamp, the LED lamp comprising:
an Edison screw having an electrical contact;
a first PCB layer coupled to the electrical contact;
a second PCB layer, the second PCB layer further comprising a plurality of LEDs; and
a heat sink configured between the first and second PCB layers, and secured by a plurality of elongated bolts.

17. The LED lamp of claim 16, the heat sink comprising a plurality of circular aluminum plates aligned perpendicularly with respect to the plurality of elongated bolts; wherein further four elongated bolts secure quarter portions of the plurality of aluminum plates.

18. The LED lamp of claim 16, the plurality of LEDs comprising:
a first LED at a center of the second PCB layer;
an arrangement of six LEDs arranged concentrically around the first LED; and
an arrangement of eight LEDs arranged concentrically around the first LED and the arrangement of six LEDs.

19. The lighting system of claim 16 further comprising a protective housing to the first PCB layer.
